(19) United States
(12) Patent Application Publication
(10) Pub. No.: US 2022/0330263 A1
(43) Pub. Date: Oct. 13, 2022

(54) COMPUTING DEVICE COMPRISING A POOL OF TERMINAL DEVICES AND A CONTROLLER

(71) Applicant: Nokia Technologies Oy, Espoo (FI)

(72) Inventors: Karsten PETERSEN, Aalborg (DK); Bent RYSGAARD, Aalborg (DK); Lars CHRISTENSEN, Aalborg (DK); Frank FREDERIKSEN, Klarup (KR); Rafhael Amorim, Aalborg (DK)

(73) Assignee: Nokia Technologies Oy, Espoo (FI)

(21) Appl. No.: 17/754,204

(22) PCT Filed: Sep. 18, 2020
(86) PCT No.: PCT/EP2020/076119

§ 371 Date: Mar. 25, 2022

(30) Foreign Application Priority Data
Sep. 26, 2019 (FI) 20195819

(51) Int. Cl. H04W 72/08; H04W 72/04

(52) U.S. Cl. CPC H04W 72/087; H04W 72/048

(57) ABSTRACT

According to an aspect, there is provided a controller of a pool of terminal devices comprising means for performing the following. Initially, information on requirements of data traffic to be handled by the pool of terminal devices and data traffic statistics for the pool are maintained in a memory of the controller. Upon receiving results of scanning of available radio access networks and capabilities from one or more primary terminal devices, the controller analyzes the results of the scanning, the requirements of the data traffic and the data traffic statistics to determine optimal radio access configurations for the pool of terminal devices for satisfying the requirements of the data traffic. Then, the controller configures the pool of terminal devices for providing radio access according to the optimal radio access configurations. Finally, the controller provides radio access using the pool of terminal devices according to the optimal radio access configurations.

### TECHNICAL FIELD

Various example embodiments relate to wireless communications.

### BACKGROUND

Maintaining high reliability and/or availability for certain critical communication links is of high importance in many communication scenarios. Applications in the so-called Industry 4.0 and massive machine type communications (mMTC) are some examples of communication scenarios where such critical communication links may be present. In such scenarios, there may be several hard-to-predict non-deterministic factors which may compromise the reliability and/or availability, for example, device stability, hardware failures, interference from other devices and peaks of latency during handover events. Consequently, there is a need for a solution for overcoming or at least alleviating the problem of how to ensure high reliability and/or availability, especially for certain communication links known to be critical for the operation of the communication system.

### BRIEF DESCRIPTION

According to an aspect, there is provided the subject matter of the in-dependent claims. Embodiments are defined in the dependent claims. The scope of protection sought for various embodiments of the invention is set out by the independent claims. The embodiments and features, if any, described in this specification that do not fall under the scope of the independent claims are to be interpreted as examples useful for understanding various embodiments of the invention.

### BRIEF DESCRIPTION OF DRAWINGS

In the following, example embodiments will be described in greater detail with reference to the attached drawings, in which

FIGS. 1 and 2 illustrate exemplary wireless communication systems and apparatuses according to embodiments;

FIGS. 3A, 3B, 3C, 4A, 4B, 4C, 5A, 5B, 5C and 6 illustrate exemplary processes according to embodiments;

FIG. 7 illustrates an exemplary communication scenario according to embodiments; and

FIGS. 8 and 9 illustrate apparatuses according to embodiments.

### DETAILED DESCRIPTION OF SOME EMBODIMENTS

The following embodiments are only presented as examples. Although the specification may refer to “an”, “one”, or “some” embodiment(s) and/or example(s) in several locations of the text, this does not necessarily mean that each reference is made to the same embodiment(s) or example(s), or that a particular feature only applies to a single embodiment and/or example. Single features of different embodiments and/or examples may also be combined to provide other embodiments and/or examples.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

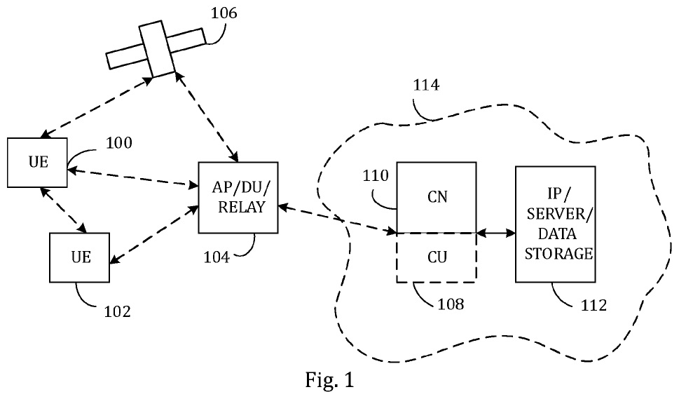

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g)NodeB) 104 providing the cell (and possibly also one or more other cells). The cells may be equally called sectors, especially when multiple cells are associated with a single access node (e.g., in tri-sector or six-sector deployment). Each cell may define a coverage area or a service area of the access node. Each cell may be, for example, a macro cell or an indoor/outdoor small cell (a micro, femto, or a pico cell). The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signaling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. Each user device may comprise one or more antennas. It should be appreciated that a user device may also be a nearly exclusive uplink only device, of which an example is a camera or video camera loading images or video clips to a network. A user device may also be a device having capability to operate in (Industrial) Internet of Things ((I)IoT) network which is a scenario in which objects are provided with the ability to transfer data over a network without requiring human-to-human or human-to-computer interaction. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

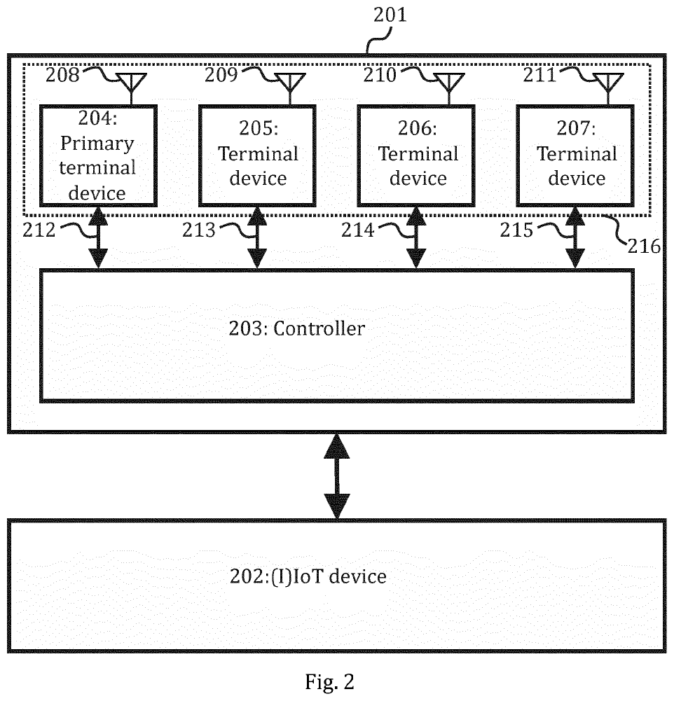

In some embodiments, one or each of the elements 100, 102 may correspond to a centrally controlled pool of terminal devices (e.g., as illustrated by and discussed in relation to element 201 of FIG. 2). Each terminal device (i.e., called equally a user device) may be defined as discussed in the previous paragraph.

The exemplifying radio access network of FIG. 1 may also comprise one or more (dedicated) IoT or IIoT devices (not shown in FIG. 1) which are able to communicate with the access node 104 only via one or more of the user devices 100, 102 (i.e., they are unable to communicate directly with the access node 104).

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas (each of which may comprise multiple antenna elements), many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications, including vehicular safety, different sensors and real-time control. 5G is expected to have multiple radio interfaces, namely below 6 GHz, cmWave and mmWave, and also being integratable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 104) and non-real time functions being carried out in a centralized manner (in a centralized unit, CU 108).

It should also be understood that the distribution of labor between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). Each satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g) NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

The embodiments to be discussed below in detail may be specifically applied to high reliability applications and/or high availability devices where reliability and/or availability of certain communication links is highly critical for successful operation. So-called Industry 4.0 and massive machine type communications (mMTC) are non-exhaustive examples of communication scenarios where such critical communication links may exist. There are several non-deterministic (and thus hard-to-predict) factors which may compromise the reliability and/or availability in such cases, such as device stability, hardware failures, interference from other devices and peaks of latency during handover events.

In wireless communications, reliability and availability are closely related concepts which are, however, not fully interchangeable. In the context of the following embodiments, reliability and availability may be defined as follows. Reliability may be defined as a probability that a device, a system or a connection will meet certain performance standards (e.g., in terms of bit rate) for a desired time duration. On the other hand, availability may be defined as a percentage of time that a device, a system or a connection remains operational under normal circumstances in order to serve its intended purpose.

One option for improving reliability and/or availability would be to use multiple terminal devices (a pool of terminal devices) in parallel for handling (i.e., transmitting and/or receiving) the same data. In this case, if one of the terminal devices is unable to transmit and/or receive the data, the other terminal device(s) in the pool may still be able to transmit and/or receive the data successfully. For example, the same data could be transmitted using multiple different frequency bands and/or multiple different radio access networks (RANs) with multiple different terminal devices to ensure redundancy/availability.

However, if multiple terminal devices are grouped together through the same radio access network (RAN) (assuming that the terminal devices within this group or pool have similar capabilities), the choice of frequency bands is normally not optimal as the radio access network (or specifically the corresponding access node) carries out the scheduling decisions in a centralized manner without any knowledge of the grouping of the terminal devices in the other end. These scheduling decisions are based on the capabilities (e.g., supported frequency bands) of the terminal devices in the pool which are reported to the access node (e.g., gNB) of the RAN. Conventionally, the terminal devices report all their supported capabilities to the access node. On the other hand, if multiple terminal devices are connected through different RANs in order to improve reliability and/or availability, there is less flexibility in the scheduling. For example, if three terminal devices are assigned to three different RANs in a given region and one of the RANs is detected to provide poor coverage for a corresponding terminal device, said terminal device cannot be easily repurposed towards different carriers in the other two RANs. Therefore, it would be beneficial if not only the choice of RAN for each terminal device in the pool of terminal devices but also the capabilities of each terminal device which are reported by said terminal device to the access node of the RAN could be dynamically adjusted. This would effectively mean that the terminal devices would report only capabilities (e.g., frequency bands) which they are interested in using at a given time instance which would, in turn, limit the scheduling options of the access node (i.e., force the access node to perform the scheduling in a particular way).

In general, a variety of adverse changes may occur in a communications system (e.g., system of FIG. 1) during its operation. Many of said adverse changes could be overcome or at least alleviated if dynamically adjusting the RAN selection and capabilities (e.g., supported frequency bands) of the terminal devices in the pool which are reported to RANs would be possible. Some examples of such adverse changes are:
increase of network load due to an increase in the number of terminal devices and/or due to an increase in use of the capacity for non-URLLC (non-Ultra-Reliable Low-Latency Communication) related data transfers,
blocking of a particular line-of-sight connection by an obstruction,
movement of a terminal device, e.g., to a compromised position,
increase in power consumption of a terminal device,
failure in a core network and
movement of a terminal device to a coverage area of a local RAN but still maintaining access to a public RAN.

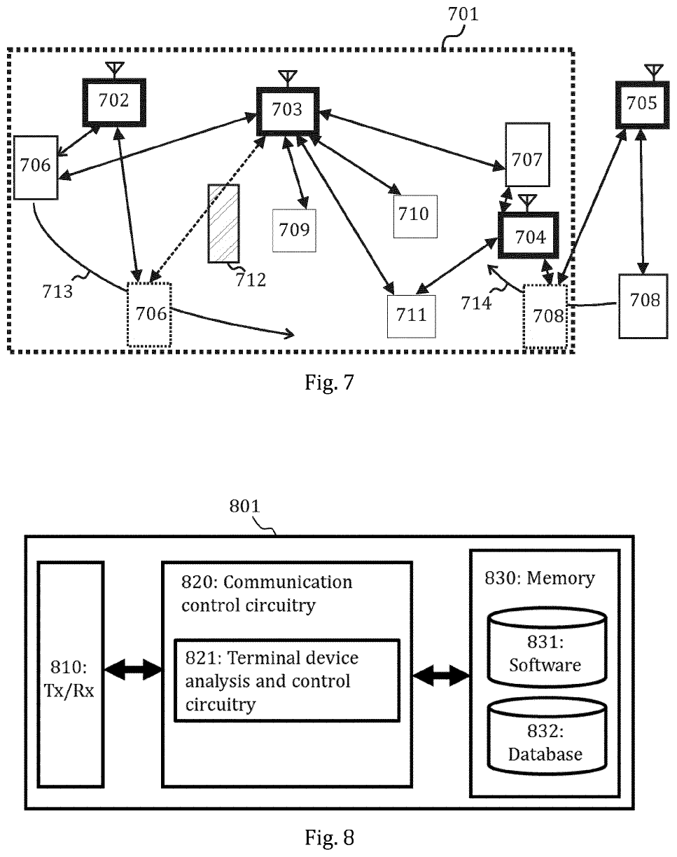

Some of said adverse effect are discussed further in connection with an exemplary scenario below in relation to FIG. 7.

FIG. 2 illustrates a first computing device 201 according to embodiments for providing radio access while overcoming or at least alleviating at least some of the problems discussed above. FIG. 2 further illustrates a second computing device 202 which is a computing device requiring or requesting radio access and which is connected (or capable of being connected) to the first computing device 201 using a wired or wireless communication link (e.g., using Bluetooth, Bluetooth Low Energy, Ethernet, Zigbee or WIFI). Specifically, the second computing device 202 may be, for example, an Internet of Things (IoT) device or an Industrial Internet of Things (IIoT) device. The second computing device 202 may be a computing device which requires or at least benefits from (high) reliability and/or availability. For example, the second computing device 202 may be a (dedicated) computing device involved in handling of emergency situations, video streaming, healthcare, military, traffic control and/or autonomous vehicles. The second computing device 202 may be a user device.

The first computing device 201 comprises a pool of terminal devices 216 and a controller 203 (equally called a controller apparatus or entity) for managing said pool of terminal devices 216. For enabling said management of the pool of terminal devices 216, each terminal device 204, 205, 206, 207 in the pool 216 is connected to the controller 203 via a signaling interface 212, 213, 214, 215 for exchanging signaling information. The first computing device 201 may be called a centrally controlled pool of terminal devices. The pool of terminal devices 216 and the controller 203 forming the first computing device 201 may be enclosed in a singular case, casing or chassis (which may be partially open in some embodiments) and/or they may be mounted on a common frame or chassis.

The pool of terminal devices 216 comprises one or more so-called primary terminal device 204 (in the illustrated examples, a single primary terminal device) and one or more other (secondary) terminal devices 205, 206, 207 (in the illustrated example, three other terminal devices). In some embodiments, the pool of terminal devices 216 may consists of only one or more primary terminal devices 204. Each primary terminal 204 device in the pool 215 should at least be able to perform scanning of available radio access networks and capabilities of said radio access networks (though the one or more secondary terminal devices in the pool may also have these functionalities). The capabilities of a radio access networks (which are resolved by scanning) may comprise, for example, frequency bands supported by the radio access network, carrier aggregation capabilities and/or (average) signal strength provided by the radio access network. The role of the primary terminal device 204 is discussed in detail in relation to further embodiments. The terminal devices 204, 205, 206, 207 in the pool 216 may be located in close proximity of each other so that the radio environment experienced by each terminal device at a given moment is (effectively or approximately) the same. The terminal devices 204, 205, 206, 207 in the pool 216 may comprise one or more terminal devices of different types and/or models having different sets of capabilities (e.g., in terms of supported radio access technologies and/or frequency bands). In some other embodiments, the terminal devices 204, 205, 206, 207 in the pool 216 may be identical to each other. Each terminal device 204, 205, 206, 207 may correspond to a complete and separate transceiver chain (that is, the terminal devices 204, 205, 206, 207 may be separate hardware entities). Each of the terminal devices 204, 205, 206, 207 in the pool 216 may correspond to either of terminal devices 100, 102 of FIG. 1. In some embodiments, each terminal device 204, 205, 206, 207 in the pool 216 may comprise at least one SIM card.

While FIG. 2 illustrates only a single primary terminal device 204, in other embodiments, one or more primary terminal devices (i.e., a pool of one or more primary terminal devices) may be employed. Assigning multiple primary terminal device may be necessary, for example, in cases where a single primary terminal device would be incapable of performing a complete scan of available radio access network and their capabilities due to a limitation in the capabilities of said single primary terminal device (e.g., lack of support for a particular relevant frequency band).

Each terminal device 204, 205, 206, 207 comprises at least one antenna 208, 209, 210, 211. Specifically, each terminal device 204, 205, 206, 207 may comprise at least one multi-band antenna and/or at least one single-band antenna. The pool of terminal devices 216 may comprise one or more multi-band terminal devices (each comprising at least one multi-band antenna or at least two single-band antennas). Preferably, all the terminal devices 204, 205, 205, 207 are multi-band terminal devices each of which comprises at least one multi-band antenna.

The controller 203 is a computing device which may be used for monitoring the radio conditions (i.e., the radio environment) using the primary terminal device 204 (or in general, one or more primary terminal devices), adjusting the capabilities of the individual terminal devices 204, 205, 206, 207 in the pool 216 (or specifically the capabilities reported to the RANs) to optimize radio resource usage and for providing radio access using the pool of terminal devices 216 (or a subset therein) in a controlled and centralized manner for the second computing device 202 (and/or for other external computing devices). For example, the controller may be used to duplicate a particular data stream and transmit it using two different terminal devices in the pool using different RANs and/or frequency bands to provide redundancy. Conversely, the controller 203 may be used to merge data streams (e.g., by removing redundant data packages) from said two different terminal devices in reception. Terminal devices may be added to and removed from the pool 216 dynamically by the controller 203 during the operation of the first computing device 201. At any given time instance, one or more terminal devices in the pool 216 may be set by the controller 203 as inactive or dormant if requirements for the data traffic to be handled (e.g., in terms of reliability and/or data speed) can be met even without said one or more terminal devices.

The controller 203 may be located between the application layer and the pool of terminal devices 216. Alternatively, one of the terminal devices in the pool may be assigned the role of the controller 203, i.e., the controller 203 may be a terminal device.

The second computing device 202 may be, as mentioned above, an IoT or IIoT device. Said IoT or IIoT device may be a part of an IoT or IIoT network, respectively. For example, said IoT or IIoT device may be a high-reliability sensor (device) which may be connected wirelessly or using a wired connection to the first computing device 201. Examples of application areas employing IIoT devices which may especially benefit from embodiments to be discussed below include, for example, motion control and autonomous vehicles. In general, the second computing device 202 may be any computing device which is able to connect to the first computing device and is in need of radio access. The first computing device 201 may be seen by the second computing device 202 as a singular terminal device (i.e., the second computing device 202 operates towards the first computing device 201 in a similar or the same manner as when communicating with a singular terminal device). The second computing device 202 may be a high availability and/or high reliability device.

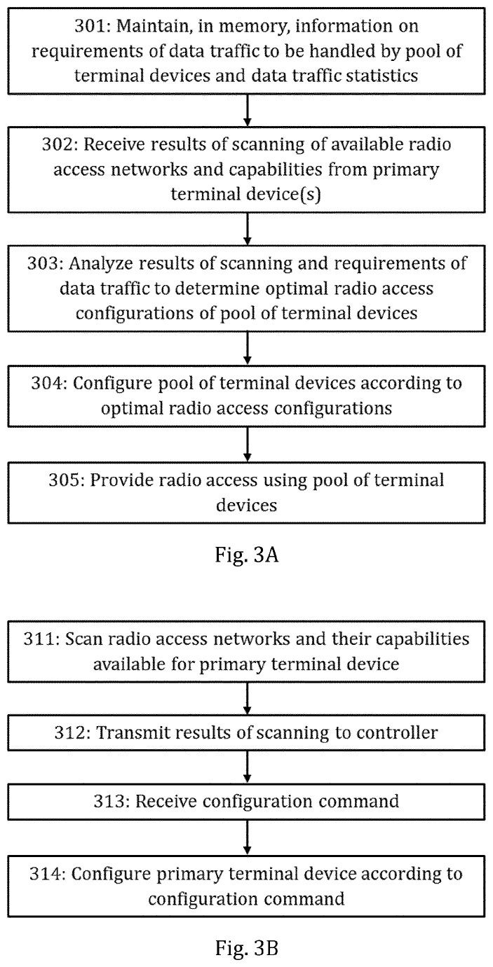

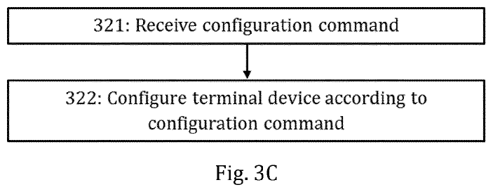

FIGS. 3A, 3B and 3C illustrate processes according to embodiments for configuring a pool of terminal devices for providing radio access in a controlled manner to meet the requirements of the data traffic. The illustrated processes of FIGS. 3A, 3B and 3C may be performed in parallel by a controller for controlling a pool of terminal devices, one or more primary terminal devices in the pool of terminal devices and one or more secondary (i.e., non-primary) terminal devices in the pool of terminal devices, respectively. In some embodiments, the pool of terminal devices may consist of only one or more primary terminal devices and thus the process of FIG. 3C may not be carried out by any terminal devices in the pool. The controller and each of the pool of terminal devices may be as electrically connected to each other and form a singular computing device. Specifically, the illustrated processes of FIGS. 3A, 3B and 3C may be performed by the controller 203, the primary terminal device 204 and any of terminal devices 205, 206, 207 of FIG. 2, respectively. In the following, the processes of FIGS. 3A, 3B and 3C are discussed in parallel for clarity.

Referring to FIG. 3A, it is initially assumed, in this embodiment, that information on requirements (i.e., expected or targeted properties) of data traffic to be handled by a pool of terminal devices and data traffic statistics (equally called data transfer statistics) for the pool of terminal devices are maintained in a memory of the controller in block 301. The data traffic may comprise one or more data streams, each of which may be associated with separate requirements.

The information on requirements of data traffic may comprise, for example, information on one or more expected (minimum) bit rates of the data traffic, one or more expected reliabilities (or equally one or more expected values of a reliability metric) associated with the data traffic and/or one or more expected availabilities (or equally one or more expected values of an availability metric) associated with the data traffic. In some embodiments, at least one of an expected reliability and an expected availability is included in the information on requirements of data traffic. The expected reliability and availability may specifically be expected reliability and availability of a radio access connection to be provided (by the controller using the pool of terminal devices). The expected reliability may be given as a probability that pre-defined performance standards (e.g., in terms of bit rate, latency, redundancy and/or error rates) for a pre-defined time duration are reached or as a mean time between failures. The availability may be given as a percentage of time that a radio access connection remains operational under normal circumstances in order to serve its intended purpose. The expected reliability (or the reliability metric) may alternatively correspond to Block Error Rate (BLER) (i.e., a ratio of the number of erroneous blocks to the total number of blocks), a packet loss probability, a probability of success or a reliability requirement (e.g., 99.999% defined for URLLC). The information on requirements of data traffic to be handled may have been provided by a computing device to which radio access is to be provided (e.g., an IIoT or IoT device), as will be discussed in detail in relation to further embodiments

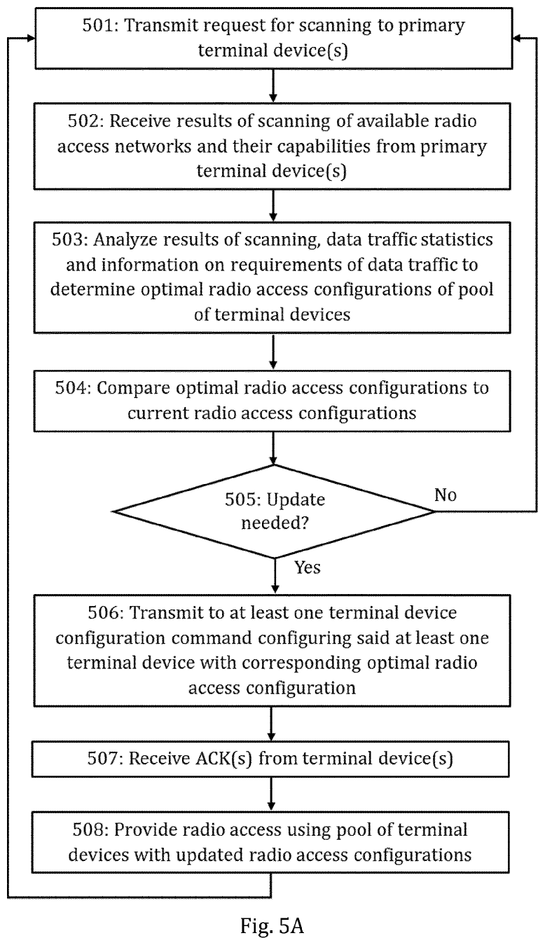

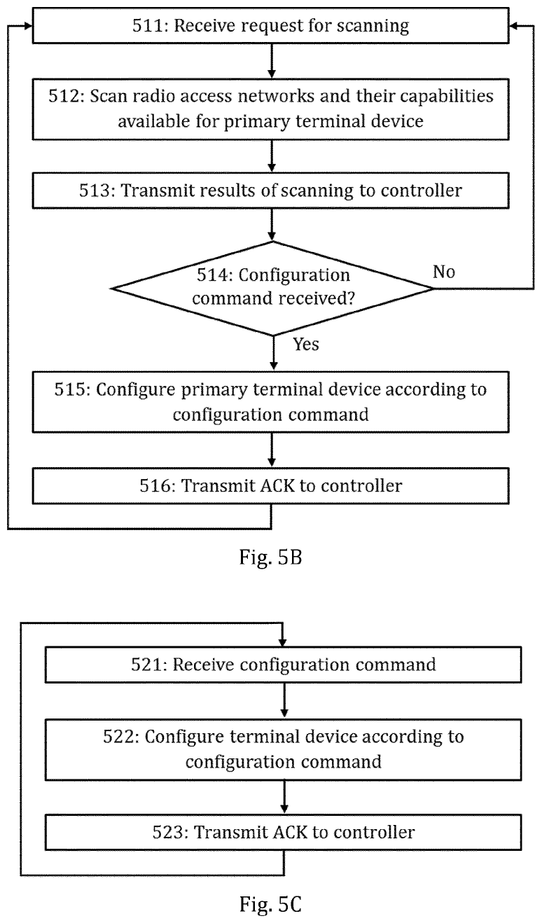

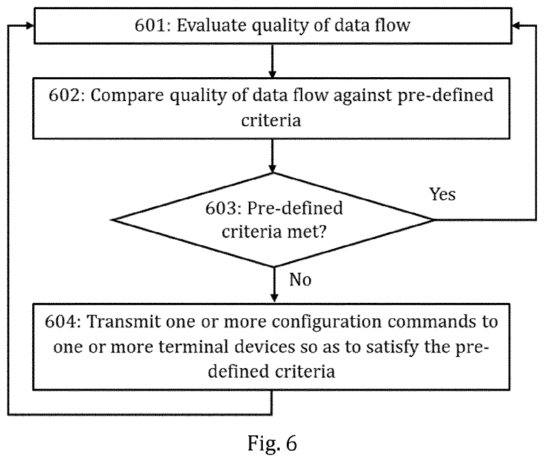

The data traffic statistics for the pool of terminal devices may comprise, for each terminal device in the pool, statistics regarding handled bit rates, throughput, total traffic handled within a pre-defined time frame such as a day, reliability, availability and/or capabilities (e.g., frequency bands) used. The data traffic statistics may have been aggregated (or generated) by monitoring data traffic over time during normal operation and/or during dedicated trials. To give an example of a dedicated trial, the controller may configure all the terminal devices in the pool to transmit data simultaneously for a predefined amount of time during which the controller analyzes the data traffic of each terminal device in order to generate (initial) data traffic statistics for the pool of terminal devices. The data traffic statistics may be updated periodically or continuously based on information on data traffic handled by the pool of terminal devices received by the computing system. In some embodiments, the data traffic statistics may be aggregated (or generated), at least in part, based on running (continuously or periodically) the process according to FIG. 5A and/or the process according to FIG. 6.

Knowing the requirements of data traffic to be handled is, however, not sufficient as also the current status of the RANs needs to be known before the controller may determine how to best configure the terminal devices in the pool to meet the requirements which are expected from the data traffic. To enable this, each primary terminal device scans, in block 311 of FIG. 3A, radio access networks available for the primary terminal device and capabilities of said radio access networks (which are determined to be available). The capabilities of a radio access network may comprise at least frequency bands (or a frequency band) supported by the radio access network, carrier aggregation capabilities and/or (average) signal strength provided by the radio access network. This is the main functionality which differentiates the one or more primary terminal devices from the other (secondary) terminal devices in the same pool. After the scanning, each primary terminal device in the pool transmits, in block 312, results of the scanning to the controller via a first signaling interface between said primary terminal device and the controller.

Referring back to FIG. 3A, the controller receives, in block 302, the results of the scanning of available radio access networks and capabilities of said available radio access networks by the one or more primary terminal devices of the pool of terminal devices from the one or more primary terminal devices via corresponding one or more first signaling interfaces. The controller analyzes, in block 303, the results of the scanning, the requirements of data traffic to be handled by the pool of terminal devices and the data traffic statistics to determine optimal radio access configurations for the pool of terminal devices for satisfying the requirements of the data traffic. Specifically, the determining of the optimal radio access configurations in block 303 may comprise determining which terminal device or devices to use for handling (or carrying) which data stream of said data traffic. In some embodiments, the number of terminal devices used for handling the data traffic (i.e., the number of active terminal devices at a given time instance) may be predefined. Preferably, said pre-defined number of terminal devices is smaller than the number of terminal devices in the pool. Further, said determining may comprise determining, for each (active) terminal device in the pool of terminal devices, which radio access network to use and which capabilities to indicate to said radio access network (i.e., to an access node of said radio access networks), for example, based on availability of Subscriber Identity Module, SIM, cards of the pool of terminal devices. The capabilities may comprise, here, capabilities regarding supported frequency bands and optionally carrier aggregation capabilities. As a general principle, the controller may determine the optimal radio access configurations so that the terminal devices which are to handle high-volume traffic are configured to indicate capabilities reflecting this elevated need and conversely that the terminal devices handling only low-volume traffic (e.g., duplicated communication for reliability) are configured to indicate only limited capabilities to the access nodes. In some cases, the controller may determine that one or more terminal devices in the pool should be inactive or dormant (i.e., it should not use any radio access network). In some embodiments, said inactive or dormant devices may be used for high bandwidth transfers.

In some embodiments, optimal radio access configurations for at least two terminal devices of the pool of terminal devices correspond to a duplication of a data stream (fully or only partially) using different frequency bands and/or radio access networks in said at least two terminal devices so as to provide increased reliability. Additionally or alternatively, optimal radio access configuration for a terminal device in the pool of terminal devices may correspond to a duplication of a data stream of the data traffic using two different frequency bands and/or two different radio access networks (of the same terminal device) so as to provide increased reliability. Additionally or alternatively, optimal radio access configurations for at least two terminal devices in the pool of terminal devices may be defined so as to avoid concurrent handover with said at least two terminal devices. Such optimal radio access configurations are obviously especially pertinent in embodiments where high reliability and/or availability is to be provided for a data stream.

The controller configures, in block 304, the pool of terminal devices for providing radio access according to the optimal radio access configurations via signaling interfaces between the controller and the pool of terminal devices. The configuring in block 304 may comprise transmitting configuration commands to the pool of terminal devices or at least one configuration command to at least one of the terminal devices in the pool (that is, to at least one terminal device deemed to require (re)configuration). Each configuration command may comprises at least information on a radio access network to be used and capabilities (e.g., one or more frequency bands) to be indicated to said radio access network. In some embodiments, configuration command(s) transmitted to secondary terminal device(s) which have not yet been initialized may comprise an initialization command for initializing said secondary terminal device, as will be discussed in more detail in relation to further embodiments.

Referring to FIGS. 3B and 3C, the configuration may be carried out in a similar manner for each of the one or more primary terminal devices and, if any exist in the pool, for the one or more secondary terminal devices (apart from the possible initialization required for some of the one or more secondary terminal devices). Each (primary or secondary) terminal device receives, in blocks 313, 321, configuration commands for configuring a respective terminal device according to a corresponding optimal radio access configuration determined by the controller from the controller via respective signaling interfaces. In response to the receiving of the configuration command, each (primary or secondary) terminal device configures, in blocks 314, 322, themselves according to the received configuration commands (i.e., according to optimal radio access configurations determined for them by the controller). The configuring in blocks 314, 322 may comprise at least attaching (or connecting) to a radio access network defined in the configuration command and subsequently indicating only the capabilities of the terminal device specified in the received configuration command to the radio access network (or specifically to an access node of the radio access network via a wireless communication link).

Finally after the pool of terminal devices has been configured, the controller is able to provide, in block 305, radio access using the pool of terminal devices according to the optimal radio access configurations. Specifically, the radio access may be provided for a computing device (e.g., an IIoT device) associated with said data traffic maintained in the memory of the controller. While providing the radio access using the pool of terminal devices according to the optimal radio access configuration in block 305, the controller may update the data traffic statistics maintained in the memory (according to the data traffic handled by the pool of terminal devices).

In some embodiments, the processes illustrated in FIGS. 3A, 3B and 3C may be repeated periodically to dynamically adapt to changing radio environment in terms of RAN and capability (e.g., frequency band) availability. The repetition may correspond to a pre-defined period. In other embodiments, the period of repetition may be adaptive, for example, determined based on the previously collected data. If degradation in the provided radio access connections is detected by the controller, the period may be reduced so as to be able to detect and react to degradation faster. Correspondingly, the period may be increased in the case that the degradation is detected by the controller to reduce. The detecting of degradation may be correspond to the processes discussed in relation to FIG. 5A and/or FIG. 6.

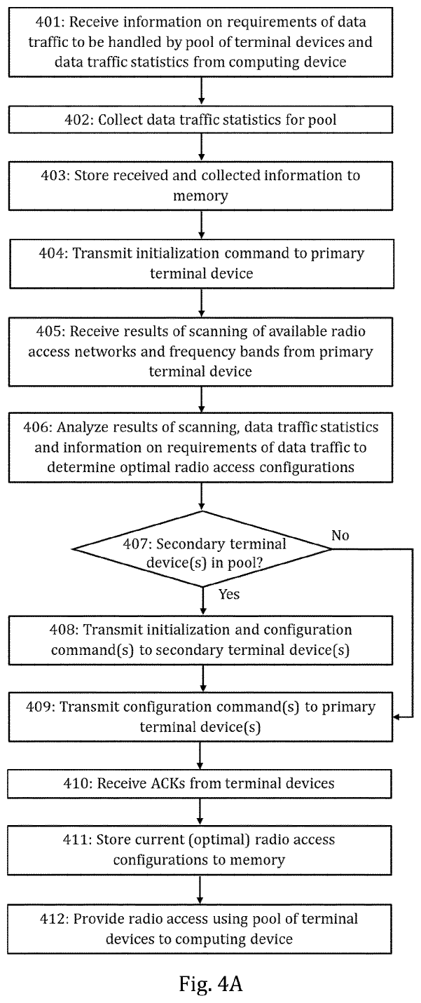

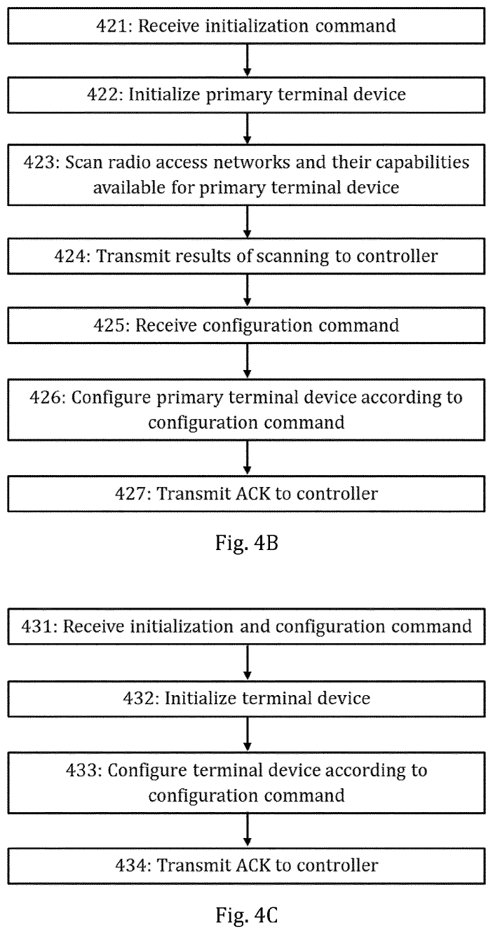

FIGS. 4A, 4B and 4C illustrate alternative processes according to embodiments for configuring a pool of terminal devices for providing radio access in a controlled manner to meet the requirements of the data traffic. Similar to FIGS. 3A, 3B and 3C, the illustrated processes of FIGS. 4A and 4B and 3C may be performed in parallel by a controller for controlling a pool of terminal devices, one or more primary terminal devices in the pool of terminal devices and one or more secondary (i.e., non-primary) terminal devices in the pool of terminal devices, respectively. The pool of terminal devices may comprise one or more secondary terminal devices or zero secondary terminal devices. Specifically, the illustrated processes of FIGS. 4A, 4B and 4C may be performed by the controller 203, the primary terminal device 204 and any of terminal devices 205, 206, 207 of FIG. 2, respectively. In the following, the processes of FIGS. 4A, 4B and 4C are discussed in parallel.

In the embodiments illustrated in FIGS. 4A, 4B and 4C, it is assumed that initially no pool of terminal devices has been set up or initialized. The setting up of the pool of terminal devices is started by a computing device (e.g., an IIoT or IoT device) transmitting at least information on requirements of data traffic to be handled by the pool of terminal devices via a wired or wireless communication link to a controller. The requirements of the data traffic may be specifically requirements for radio access for said computing device. Referring to FIG. 4A, the controller receives, in block 401, said information on the requirements of the data traffic via said wired or wireless communication link from said computing device (e.g., IIoT device). The controller collects, in block 402, data traffic statistics for the pool of terminal devices, e.g., by conducting one or more dedicated trials with the pool of terminal devices. In some embodiments, instead of or in addition to the controller actively collecting the data traffic statistics itself, the data traffic statistics may be acquired or received in block 402 by the controller from a (dedicated) remote server (or other (remote) computing device) for collecting and maintaining data traffic statistics for a plurality of terminal devices (comprising the pool of terminal devices) via a second signaling interface. Consequently, the controller stores, in block 403, said received and collected information to a memory of the controller. Then, the controller transmits, in block 404, an initialization command to one or more primary terminal devices via one or more (respective) first signaling interfaces between the controller and the one or more primary terminal devices.

In some embodiments, the pool of terminal devices may consist solely of primary terminal devices (i.e., terminal devices configured to perform the process of FIG. 4B). Obviously, in such embodiments the process of FIG. 4B is not carried out at all.

In some embodiments, the controller may be able to assign and reassign the roles of the primary terminal device (i.e., terminal device configured to carry out the process of FIG. 413) and the secondary terminal device (i.e., terminal device configured to carry out the process of FIG. 4C) to the terminal devices in the pool on-the-fly based on, e.g., requirements of data traffic to be handled by the pool of terminal devices, data traffic statistics for the pool of terminal devices and/or the results of the scanning by the one or more (current) primary terminal devices. In other words, the controller may change an assignment of at least one terminal device in the pool of terminal devices from a primary terminal device to a secondary terminal device or from a secondary terminal device to a primary terminal device so as to enable more comprehensive scanning of radio access network and capabilities thereof using the one or more primary terminal devices in the pool. For example, the controller may assign a second primary terminal device to be a primary terminal device if it is detected that the capabilities of the (first) primary terminal device are not sufficient to cover all the frequency bands (and/or other capabilities) of interest. In such a case, the first primary terminal device may be assigned to be a secondary terminal device (if the second primary terminal device is able to cover all the relevant radio access technologies and capabilities alone) or it may retain its role as a primary terminal device so that the scanning may be performed with two primary terminal devices (having different capabilities). The information on the capabilities of the terminal device in the pool may be included in the data traffic statistics maintained in the memory of the controller.

Referring to FIG. 4B, each of the one or more primary terminal devices receives, in block 421, the initialization command and consequently initializes, in block 422, themselves. The initialization for a primary terminal device may comprise, for example, powering up the primary terminal device and/or performing preliminary configuration of the primary terminal device. Once a primary terminal device (of the one or more primary terminal devices) has been initialized, the primary terminal device scans, in block 423, radio access networks and capabilities of said (available) radio access networks and transmits, in block 424, the results of the scanning to the controller, similar to as described in relation to blocks 311, 312 of FIG. 3. The initialization command may comprise a request for performing the scanning or the scanning may be performed automatically after the initialization (without explicit prompting by the controller).

Referring to FIG. 4A, the controller receives, in block 405, results of the scanning from the one or more primary terminal devices via the one or more first signaling interfaces. Block 405 as well as block 406 may be carried out similar to as described in relation to blocks 302, 303 of FIG. 3, respectively. It should be noted that here optimal radio access configurations of the pool of terminal devices determined in block 406 are specifically optimal for serving the aforementioned computing device in need of radio access. After the optimal radio access configurations have been determined in block 406, the controller determines, in block 407, whether the pool of terminal devices comprises any secondary terminal device (i.e., terminal devices which are not primary terminal devices). In response to the pool of terminal devices comprising one or more secondary terminal devices, the controller transmits, in block 408, an initialization and configuration command for initializing and configuring one or more secondary terminal devices according to corresponding optimal radio access configurations to said one or more secondary terminal device in the pool via corresponding signaling interfaces. The initialization and configuration command may consist of a single joint initialization and configuration command (i.e., a single message) or separate commands for initialization and configuration (i.e., multiple messages). The controller transmits, in block 409, one or more configuration commands for (re)configuring the one or more primary terminal devices to the one or more primary terminal devices, respectively. In response to the pool of terminal devices comprising no secondary terminal devices in block 407, block 408 is omitted, that is, the process proceeds directly from block 407 to block 409. The aforementioned two actions pertaining to blocks 408, 409 may be carried out in any order or in parallel.

Referring to FIG. 4C, it is assumed that the pool of terminal devices comprises one or more secondary terminal devices. Each secondary terminal device of the one or more secondary terminal devices receives, in block 431, the initialization and configuration command from the controller via a corresponding signaling interface. Consequently, each secondary terminal device initializes, in block 432, itself (similar to as described for the one or more primary terminal devices in relation to block 422) and configures, in block 433, itself according to the initialization and configuration command (that is, according to a corresponding optimal radio access configuration determined by the controller and defined in the received initialization and configuration command). The configuring in block 433 may be carried out as described in relation to previous embodiments, that is, the secondary terminal device may attach to a radio access network defined in the initialization and configuration command and indicate to said radio access network only capabilities defined in said command.

Referring to FIG. 4B, each of the one or more primary terminal devices receives, in block 425, the configuration command from the controller via a corresponding first signaling interface. Consequently, each primary terminal device configures, in block 426, itself according to the configuration command (that is, according to an optimal radio access configuration determined by the controller for the said primary terminal device). The receiving in block 425 and the configuring in block 426 may be carried out as described in relation to previous embodiments.

In the illustrated embodiment, it is assumed that the configuration of both primary and secondary terminal devices (in block 426 of FIG. 4B and block 433 of FIG. 4C, respectively) is successful. Thus, both primary and secondary terminal devices transmit, respectively in block 427 of FIG. 4B and block 434 of FIG. 4C, a positive acknowledgment (ACK) to the controller via respective signaling interfaces in response to a successful configuration. In some embodiments, if a configuration of any terminal device is unsuccessful for any reason, a negative acknowledgment may be transmitted to the controller instead via the same signaling interface.

Referring to FIG. 4A, in response to receiving the positive acknowledgment(s) from the terminal devices in the pool of the terminal device via corresponding signaling interfaces in block 410, the controller may store, in block 411, information on the optimal radio access configurations as current radio access configurations of the pool of terminal devices to the memory of the controller. This information may be used later for evaluating whether or not reconfiguration is necessary, as will be discussed in relation to FIGS. 5A, 5B and 5C. The controller may, then, provide, in block 412, radio access using the pool of terminal devices to the computing device (e.g., an IIoT or IoT device) in an optimized manner using the optimal radio access configurations.

In some embodiments, the controller may wait for ACK/NACK message from the terminal devices in the pool of terminal devices for a pre-defined amount of time before timing out. In response to the timeout, the process may proceed to block 411 (if at least one ACK was received) or terminate (if no ACKs were received).

In some embodiments, in response to receiving the positive acknowledgments from the terminal devices in the pool of the terminal device via corresponding signaling interfaces in block 410, the controller may transmit an acknowledgment or confirmation message to the computing device (e.g., IIoT or IoT device) via said wired or wireless communications link in order to inform the computing device (that is, the computing device from which the requirements of the data traffic to be handled was received) that the initialization has been completed and thus the computing device may start transmitting/receiving data via the controller and the pool of terminal devices.

In some embodiments, the transmission and reception of any of said positive acknowledgments (i.e., blocks 410, 427, 434) may be omitted. Moreover, the storing of the information on the optimal radio access configurations as current radio access configurations (i.e., block 411) may be carried out any time after the optimal radio access configurations have been determined in block 406.

After the initial configuration of the pool of terminal devices has been completed, the configuration process may be repeated periodically. The configuration process carried out after the initial configuration may differ from the initial configuration process discussed in relation to FIGS. 4A, 4B and 4C in a few key ways. FIGS. 5A, 5B and 5C illustrate processes according to embodiments for configuring a pool of terminal devices assuming that at least an initial configuration has already been carried out (e.g., according to processes of FIGS. 4A, 4B and 4C). Similar to FIGS. 3A, 3B and 3C and FIGS. 4A, 4B and 4C, the illustrated processes of FIGS. 5A and 5B and 5C may be performed in parallel by a controller for controlling a pool of terminal devices, one or more primary terminal devices in the pool of terminal devices and one or more secondary (i.e., non-primary) terminal devices in the pool of terminal devices, respectively. The pool of terminal devices may comprise one or more secondary terminal devices or zero secondary terminal devices. Specifically, the illustrated processes of FIGS. 5A, 5B and 5C may be performed by the controller 203, the primary terminal device 204 and any of terminal devices 205, 206, 207 of FIG. 2, respectively. In the following, the processes of FIGS. 5A, 5B and 5C are discussed in parallel.

In the embodiments illustrated in FIGS. 5A, 5B and 5C, it is assumed that information on requirements of the data traffic to be handled by the pool of terminal devices, data traffic statistics for the pool of terminal devices and current radio access configurations of the pool of terminal devices is maintained in the memory of the controller. For example, said information may have been stored to the memory during the initial configuration of the pool of terminal devices as described in relation to blocks 401, 402, 403, 411 of FIG. 4A. It should be noted that the data traffic statistics for the pool of terminal devices maintained in the memory may also be updated during the running of the processes of FIGS. 5A, 5B and 5C.

Referring to FIG. 5A, the controller first transmits, in block 501, a request for scanning radio access networks and capabilities available for the one or more primary terminal devices of the pool of terminal devices to the one or more primary terminal devices via one or more (respective) first signaling interface between the controller and the one or more primary terminal devices. The transmission in block 501 may be carried out a pre-defined time (or a pre-defined period) after the initial configuration of the pool of terminal devices.

Referring to FIG. 5B, each primary terminal device of the one or more primary terminal devices in the pool receives, in block 511, the request for scanning radio access networks and capabilities available for said primary terminal device via a corresponding first signaling interface and consequently performs the scanning in block 512, similar to as described in relation to previous embodiments (e.g., blocks 311 of FIG. 3B and block 413 of FIG. 4B). Also similar to previous embodiments, each primary terminal device transmits, in block 513, the results of the scanning back to the controller via the one or more first signaling interfaces.

In some embodiments, the scanning in block 512 (or in block 423 of FIG. 4B) may be performed, by at least one of the one or more primary terminal devices, while handling ongoing data traffic (that is, in parallel with ongoing data transfers).

Referring to FIG. 5A, in response to receiving results of scanning from the one or more primary terminal devices via the one or more first signaling interfaces in block 502, the controller analyzes, in block 503, the results of the scanning, the requirements of the data traffic, the data traffic statistics for the pool of terminal devices to determine optimal radio access configurations for the pool of terminal devices for satisfying the requirements of the data traffic, similar to as discussed in relation to previous embodiments. As mentioned above, it is assumed here that the pool of terminal devices were already configured at an earlier time instance with radio access configurations deemed optimal at said earlier time instance. Therefore, it is possible that the pool of terminal devices is already configured in an optimal manner and thus no reconfiguration is necessary. It is also possible that reconfiguration is necessary but only for some of the terminal devices in the pool. In other words, it is possible that no significant change in the available radio access networks and frequency bands (and/or other capabilities) has occurred since the last configuration of the pool of terminal devices or that some changes have occurred, for example, the pool of terminal devices (and the controller) may have moved beyond the coverage area of a particular radio access network to which at least one terminal device in the pool is attached. Some possible changes in the radio environment triggering reconfiguration of terminal device(s) are discussed in more detail in relation to an exemplary communication scenario of FIG. 7. To determine which terminal device require reconfiguring, the controller compares, in block 504, the optimal radio access configurations to the current radio access configurations of the pool of terminal devices stored to the memory of the controller. Specifically, the controller compares, for each terminal device in the pool, an optimal radio access configuration of said terminal device to a current radio access configuration of said terminal device.

In response to an optimal radio access configuration for at least one terminal device in the pool differing from a corresponding current radio access configuration (for the same terminal device) in block 505, the controller transmits, in block 506, to each of said at least one terminal device a configuration command for (re)configuring a corresponding terminal device according to the corresponding (updated) optimal radio access configuration via a corresponding signaling interface. As described in relation above embodiments, the configuration command may comprise information at least on a radio access network to be used and capabilities to indicate to said radio access network. If there is no change in the used radio access network, the information on the used radio access network may be omitted from the configuration command.

In response to no optimal radio access configuration for any terminal device in the pool differing from a corresponding current radio access configuration in block 505, the controller may not perform any reconfiguring of the terminal devices in the pool for now.

The configuration commands transmitted by the controller according to block 506 may be handled by the one or more primary terminal devices and the one or more secondary terminal devices (if any are comprised in the pool of terminal devices) in much the same way as discussed in relation to previous embodiments. However, in contrast to the embodiments illustrated in FIGS. 4A and 4B, even if one or more secondary terminal devices are comprised in the pool of terminal devices, they do not need to be initialized at this point. In response to receiving the configuration command in block 514 of FIG. 5B or block 521 of FIG. 5C, each (primary or secondary) terminal device, respectively, configures, in block 522, itself according to the received configuration command (i.e., according to a corresponding changed optimal radio access configuration) and transmits, in block 516 of FIG. 5B or block 523 of FIG. 5C, a positive acknowledgment back to the controller via a corresponding signaling interface upon a successful completion of the (re)configuration. The configuring in block 515 and/or block 522 may be carried out as described in relation to previous embodiments, that is, the terminal device may attach to a radio access network defined in the initialization and configuration command and indicate to said radio access network only capabilities (e.g., one or more frequency bands) defined in said command. However, if the new optimal radio access configuration and the current configuration for a terminal device use the same radio access network, the attaching step may obviously be omitted. Any further features discussed in relation to handling configuration commands in previous embodiments may be applied also here. For example, also in this case a negative acknowledgment, instead of a positive acknowledgment, may be transmitted if the (re)configuration is unsuccessful.

Referring to FIG. 5A, in response to receiving at least one positive acknowledgment from at least one terminal device via at least one corresponding signaling interface in block 507, the controller may store, in block 508, information on updated optimal radio access configuration(s) to the memory of the controller and provide, in block 509, radio access using the pool of terminal devices to the computing device (e.g., an IIoT or IoT device) in an optimized manner using the updated optimal radio access configurations.

The processes described in relation to FIGS. 5A, 5B and 5C may be repeated periodically so as to react to changes in the radio environment. In other words, after a predefined period has passed after the (latest) transmission of the request for scanning to the one or more primary terminal devices (or after the latest (re)configuration of the pool of terminal devices or the latest determination that no reconfiguration is currently required), the processes of blocks 501 to 505 of FIG. 5A and blocks 511 to 514 of FIG. 5B and if deemed necessary blocks 506 to 508 of FIG. 5A, blocks 515, 516 of FIG. 5B and blocks 521 to 523 of FIG. 5B may be repeated. This pre-defined period of repetition may be the same as the pre-defined time between the initial configuration and the first reconfiguration check carried out according to FIGS. 5A, 5B and 5C.

In some embodiments, the requirements of data traffic to be handled by the pool of terminal devices may change during the performing of the processes of FIGS. 5A, 5B and 5C. For example, a computing device (e.g., an IIoT or IoT device) may transmit new requirements of the data traffic to the controller via a wired or wireless communications link. Upon reception in the controller, the new requirements may be stored to the memory of the controller. Said computing device may be the same computing device to which radio access was previously provided by the controller and the pool of terminal devices or a different computing device. In some embodiments, reception of new requirements for data traffic may automatically trigger the (re)configuration according to the processes of FIGS. 5A, 5B and 5C.

In addition or alternative to the processes of FIG. 5A, the controller may be configured to update the configuration of the pool of terminal device based on changes in the monitored quality of the data flow associated with the pool of terminal devices. FIG. 6 illustrates a process according to embodiments for performing such a functionality. The illustrated process of FIG. 6 may be performed by a controller for controlling a pool of terminal devices or specifically by the controller 203 of FIG. 2.

In the embodiment illustrated in FIG. 6, it is assumed that initial configuration for the pool of terminal devices has already been carried out (e.g., according to the processed discussed in relation to FIGS. 4A, 4B and 4C). Information on current radio access configurations of the pool of terminal devices, data traffic statistics for the pool of terminal devices and/or information on requirements for the data traffic (as set out by an IIoT or IoT device) may be maintained in the memory of the controller. For example, said information may have been stored to the memory during the initial configuration of the pool of terminal devices as described in relation to blocks 401, 402, 403, 411 of FIG. 4A.

Referring to FIG. 6, the controller evaluates, in block 601, a quality of a data flow associated with the pool of terminal devices. The controller compares, in block 602, the quality of the data flow against pre-defined criteria for the quality of the data flow. The pre-defined criteria may be based at least on requirements for the data traffic. The comparing of the quality of the data flow against pre-defined criteria in block 602 may comprise, for example, comparing measured signal strength against a pre-defined threshold for the signal strength. The pre-defined threshold may be defined, for example, so that the measured signal strength falling below the pre-defined threshold indicates a (probable) loss of line-of-sight connection for the data flow. Alternatively or additionally, the comparing of the quality of the data flow against pre-defined criteria in block 602 may comprise comparing quality of a transmission rate against a pre-defined threshold for the transmission rate and/or comparing stability of the data flow against a pre-defined threshold for stability. Said pre-defined threshold for stability may be defined to depend on the distance between the terminal device handling the data flow and a corresponding access node and frequency band used for handling said data flow.

In response to determining that the quality of the data flow fails to satisfy the pre-defined criteria in block 603, the controller transmits, in block 604, to one or more terminal devices in the pool of terminal devices via one or more corresponding signaling interfaces one or more configuration commands for reconfiguring said one or more terminal device so as to satisfy the pre-defined criteria. In response to determining that the quality of the data flow satisfies the pre-defined criteria in block 603, the controller carries out no reconfiguration of terminal devices.

The (re)configuration of the terminal devices in the pool may be carried out as discussed in relation to above embodiments and is thus not discussed here for brevity. It should be noted that the terminal devices may, also in this case, transmit a positive or negative acknowledgment back to the controller upon successful/unsuccessful configuration and the controller may, thus, following block 604 receive one or more positive or negative acknowledgment(s), similar to as discussed in relation to previous embodiments.

The processes discussed in relation to blocks 601 to 604 may be run continuously or repeated periodically (after initial configuration of the pool of terminal devices). In some embodiments, both the process of FIG. 6 and the process of FIGS. 5A, 5B and 5C may be carried out in parallel. In such embodiments, the pre-defined period of repetition may be the same or different for the two processes. Preferably, the process of FIG. 6 is repeated (considerably) more often than the processes of FIGS. 5A, 5B and 5C.

In some embodiments, in addition or alternative to the periodic repetition, the processes of FIGS. 5A, 5B and 5C and/or the process of FIG. 6 may be triggered in response to the controller detecting degradation in the quality which does not match the current knowledge the controller has about the surroundings and capabilities of the pool of terminal devices (e.g., indicating that a radio access network may be down or one of the terminals may have broken down).

FIG. 7 illustrates an exemplary communication scenario to which embodiments may be applied. The illustrated communications scenarios comprises three local access nodes 702, 703, 704 covering a certain area 701 and one public access node 705. The access nodes may specifically be gNodeBs. Further, the local access nodes 702, 703 may both support Ultra-Reliable Low-Latency Communication (URLLC) while the local access node 704 may not. The communication scenario further comprises three centrally controlled pools of terminal devices 706, 707, 708 according to embodiments, where each centrally controlled pool of terminal devices 706, 707, 708 comprises at least a pool of terminal devices and a controller for managing said pool of terminal devices. The first centrally controlled pool of terminal devices 706 may specifically handle low-bandwidth IIoT URLLC traffic, the second centrally controlled pool of terminal devices 707 may specifically handle low-bandwidth IIoT URLLC traffic as well as periodic high-bandwidth non-URLLC traffic (e.g., relating to data collection or logging) and the third centrally controlled pool of terminal devices 708 may handle only high-bandwidth non-URLLC traffic. Each centrally controlled pool of terminal devices may correspond to a first computing device 201 of FIG. 2. The communication scenario also comprises a grand master URLLC terminal device 709 providing time sensitive networking (TSN) grand master clock synchronization signal to the second local access node 703, an IIoT URLLC terminal device 710 handling low-bandwidth URLLC traffic through the second local access node 703 and a terminal device 711 handling high-bandwidth non-URLLC traffic through the third local access node 704.

In the illustrated example, the first centrally controlled pool of terminal devices 706 handling low-bandwidth IIoT URLLC traffic is attached to a first local access node 702 and to a second local access node 703. The connection to the second local access node 703 may correspond to a primary URLLC data stream for transmitting/receiving low bandwidth traffic while the connection to the first access node is a duplicated URLLC data stream for transmitting/receiving the same traffic in order to increase reliability of radio access. When the first centrally controlled pool 706 moves to a new position as indicated by element 713, the connection to the second local access node 703 becomes blocked by the obstacle 712 (that is, the signal quality of said connection decreases drastically). Due to the duplication of the URLLC data stream, the radio access is not lost even though the primary URLLC connection may be lost. The controller of the first centrally controlled pool 706 may eventually detect the decrease in the quality of data flow (e.g., according to the processes of FIG. 6) and reconfigure its pool of terminal devices at least to deactivate the redundant non-working connection to the second local access node 703 and possibly to further improve quality of the provided radio access.

The second centrally controlled pool of terminal devices 707 is attached to the second local access node 703 for handling low-bandwidth IIoT URLLC traffic and to a third local access node 704 for handling high-bandwidth non-URLLC traffic. This way the capacity of the second local access node 703 supporting URLLC is not wasted on high-bandwidth non-URLLC traffic which, in turn, ensures that high reliability in connections of the second local access node 703 is not compromised. In such cases, the connection of the second centrally controlled pool of terminal devices 707 to each access node 703, 704 is, most likely, split into different terminals. This split may be done based on the current system requirements (e.g., three terminal devices in the pool may be used for handling URLLC traffic and one terminal device may be used for handling high bandwidth traffic)

The third centrally controlled pool of terminal devices 708 may be initially attached only to the public access node 705 for handling the high-bandwidth data traffic. However, when the third centrally controlled pool 708 moves into the coverage area of the third local access node 704 as indicated with the element 714, the controller is able to smoothly switch to using also the third local access node (e.g., for improving redundancy or bit rate) while still maintaining the access to the public access node 705.

Changes which the controller of a pool of terminal devices according to embodiments may carry out dynamically based on the changes in the radio environment may, for example, include:
Handover: secure handover for a terminal device in the pool may be carried out so that the reliability or other requirements are not compromised. This may be achieved by always having another terminal device in the pool available which is not doing a handover simultaneously.
Switching to alternative radio access network: a terminal device in the pool may be configured initially to connect to a first access node of a first radio access network. If the quality of the data flow associated with said radio access network decreases, the controller may trigger a change to another terminal device in the pool camped on another radio access network (e.g., according to processes of FIG. 6).
Switching to an alternative frequency band: a terminal device may be configured initially to connect to a first access node of a first radio access network. If the controller detects that another terminal device in the same RAN but with a different frequency band support would be a better choice (e.g., in processes of FIG. 5A or 6), the controller may configure said terminal device to employ this better alternative connection.

The blocks, related functions, and information exchanges described above by means of FIGS. 3A, 3B, 3C, 4A, 4B, 4C, 5A, 5B, 5C, 6 and 7 are in no absolute chronological order, and some of them may be performed simultaneously or in an order differing from the given one. Other functions can also be executed between them or within them, and other information may be sent, and/or other rules applied. Some of the blocks or part of the blocks or one or more pieces of information can also be left out or replaced by a corresponding block or part of the block or one or more pieces of information.

FIG. 8 provides a controller 801 for controlling a pool of terminal devices according to some embodiments. Specifically, FIG. 8 may illustrate a controller configured to carry out at least the functions described above in connection with analyzing (e.g., by causing scanning), initializing and (re)configuring terminal devices in a pool of terminal devices. The controller 801 may be the controller 203 of FIG. 2 or be comprised in one of elements 100, 102 of FIG. 1. The controller 801 may comprise one or more communication control circuitry 820, such as at least one processor, and at least one memory 830, including one or more algorithms 831, such as a computer program code (software) wherein the at least one memory and the computer program code (software) are configured, with the at least one processor, to cause the controller to carry out any one of the exemplified functionalities of the controller described above. Said at least one memory 830 may also comprise at least one database 832.

Referring to FIG. 8, the one or more communication control circuitry 820 of the controller 801 comprise at least terminal device analysis and control circuitry 821 which is configured to perform analysis, initialization and/or control of a pool of terminal devices. To this end, the terminal device analysis and control circuitry 821 of the controller 801 is configured to carry out at least some of the functionalities described above by means of any of FIGS. 3A, 4A, 5A, 6 and 7 using one or more individual circuitries.

Referring to FIG. 8, the memory 830 may be implemented using any suitable data storage technology, such as semiconductor based memory devices, flash memory, magnetic memory devices and systems, optical memory devices and systems, fixed memory and removable memory.

Referring to FIG. 8, the controller 801 may further comprise different interfaces 810 such as one or more signaling interfaces (TX/RX) comprising hardware and/or software for realizing communication connectivity according to one or more communication protocols. Specifically, the one or more signaling interfaces 810 may comprise, for example, interfaces providing a connection to each terminal device in the pool of terminal devices and to one or more (external) computing devices such as IIoT devices. The one or more signaling interface 810 may provide the controller with communication capabilities to communicate (possibly via the pool of terminal devices) in a cellular or wireless communication system, to access the Internet and a core network of a wireless communications network and/or to enable communication between user devices (terminal devices) and different network nodes or elements, for example. The one or more signaling interfaces 810 may comprise standard well-known components such as an amplifier, filter, frequency-converter, (de)modulator, and encoder/decoder circuitries, controlled by the corresponding controlling units, and one or more antennas.

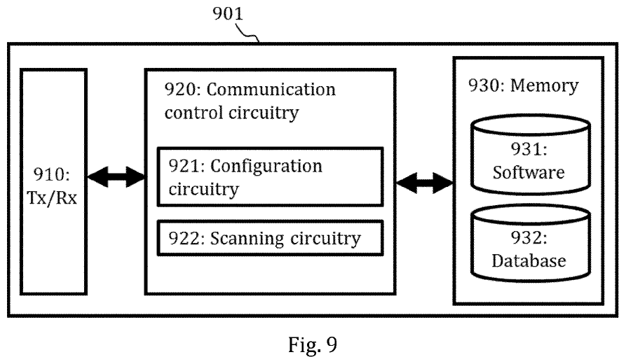

FIG. 9 provides a terminal device 901 according to some embodiments. Specifically, FIG. 9 may illustrate a terminal device configured to carry out at least the functions described above in connection with providing radio access according to its configuration, (re)configuring itself and optionally for performing scanning of radio access network and frequency bands. The terminal device 901 may be a primary terminal device or a secondary terminal device in a pool of terminal devices, as defined in relation to above embodiments. The terminal device 901 may be any of terminal devices 204, 205, 206, 207 of FIG. 2 or be comprised in one of elements 100, 102 of FIG. 1. The terminal device 901 may comprise one or more communication control circuitry 920, such as at least one processor, and at least one memory 930, including one or more algorithms 931, such as a computer program code (software) wherein the at least one memory and the computer program code (software) are configured, with the at least one processor, to cause the terminal device to carry out any one of the exemplified functionalities of the terminal device (of a primary and/or secondary terminal device) described above, respectively. Said at least one memory 930 may also comprise at least one database 932.

Referring to FIG. 9, the one or more communication control circuitry 920 of the terminal device 901 comprise at least configuration circuitry 921 which is configured to enable the terminal device to configure itself (or specifically its radio access functionalities). To this end, the configuration circuitry 921 of the terminal device 901 is configured to carry out at least some of the functionalities described above by means of any of FIGS. 3B, 3C, 4B, 4C 5B, 5C, 6 and 7 excluding the RAN/frequency scanning-related functionalities (at least blocks 311, 312 of FIG. 3B, blocks 423, 424 of FIG. 4B and blocks 511 to 513 of FIG. 5B) using one or more individual circuitries. Moreover, the one or more communication control circuitry 920 of the terminal device 901 may comprise scanning circuitry 922 which is configured to enable the terminal device to configure itself (or specifically its radio access functionalities). To this end, the scanning circuitry 922 of the terminal device 901 may be configured to carry out at least some of the functionalities described above by means of any of blocks 311, 312 of FIG. 3B, blocks 423, 424 of FIG. 4B and blocks 511 to 513 of FIG. 5B using one or more individual circuitries. The scanning circuitry 922 may or may not be included in terminal devices acting as secondary terminal devices (that is, the scanning functionalities are not needed for serving as a non-primary terminal device in the pool of terminal devices).

Referring to FIG. 9, the memory 930 may be implemented using any suitable data storage technology, such as semiconductor based memory devices, flash memory, magnetic memory devices and systems, optical memory devices and systems, fixed memory and removable memory.

Referring to FIG. 9, the terminal device 901 may further comprise different interfaces 910 such as one or more signaling interfaces (TX/RX) comprising hardware and/or software for realizing communication connectivity according to one or more communication protocols. Specifically, the one or more signaling interfaces 910 may comprise, for example, interfaces providing a connection to a controller of the pool of terminal device to which the terminal device in question belongs, to one or more terminal devices in the pool of terminal devices and to one or more access nodes of at least one wireless communication network. The one or more signaling interface 910 may provide the terminal device with communication capabilities to communicate in a cellular or wireless communication system, to access the Internet and a core network of a wireless communications network and/or to enable communication between user devices (terminal devices) and different network nodes or elements, for example. The one or more signaling interfaces 910 may comprise standard well-known components such as an amplifier, filter, frequency-converter, (de)modulator, and encoder/decoder circuitries, controlled by the corresponding controlling units, and one or more antennas.

In an embodiment, there is provided a computing device comprising a pool of terminal devices comprising one or more primary terminal devices and a controller of the pool of terminal devices connected to each terminal device in the pool via a signaling interface. The controller and the one or more primary terminal devices may be defined as described in relation to any of the above embodiments (e.g., in relation to FIGS. 8 and 9, respectively). The pool of terminal devices may further comprise one or more secondary terminal devices each of which may be defined as described in relation to any of the above embodiments (e.g., in relation to FIG. 9).

As used in this application, the term ‘circuitry’ may refer to one or more or all of the following: (a) hardware-only circuit implementations, such as implementations in only analog and/or digital circuitry, and (b) combinations of hardware circuits and software (and/or firmware), such as (as applicable): (i) a combination of analog and/or digital hardware circuit(s) with software/firmware and (ii) any portions of hardware processor(s) with software, including digital signal processor(s), software, and memory(ies) that work together to cause an apparatus, such as a terminal device or an access node, to perform various functions, and (c) hardware circuit(s) and processor(s), such as a microprocessor(s) or a portion of a microprocessor(s), that requires software (e.g. firmware) for operation, but the software may not be present when it is not needed for operation. This definition of ‘circuitry’ applies to all uses of this term in this application, including any claims. As a further example, as used in this application, the term ‘circuitry’ also covers an implementation of merely a hardware circuit or processor (or multiple processors) or a portion of a hardware circuit or processor and its (or their) accompanying software and/or firmware. The term ‘circuitry’ also covers, for example and if applicable to the particular claim element, a baseband integrated circuit for an access node or a terminal device or other computing or network device.

In an embodiment, at least some of the processes described in connection with FIGS. 3A, 3B, 3C, 4A, 4B, 4C, 5A, 5B, 5C, 6 and 7 may be carried out by an apparatus comprising corresponding means for carrying out at least some of the described processes. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry. In an embodiment, the at least one processor, the memory, and the computer program code form processing means or comprises one or more computer program code portions for carrying out one or more operations according to any one of the embodiments of FIGS. 3A, 3B, 3C, 4A, 4B, 4C, 5A, 5B, 5C, 6 and 7 or operations thereof.

Embodiments as described may also be carried out in the form of a computer process defined by a computer program or portions thereof. Embodiments of the methods described in connection with FIGS. 3A, 3B, 3C, 4A, 4B, 4C, 5A, 5B, 5C, 6 and 7 may be carried out by executing at least one portion of a computer program comprising corresponding instructions. The computer program may be provided as a computer readable medium comprising program instructions stored thereon or as a non-transitory computer readable medium comprising program instructions stored thereon. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium. Coding of software for carrying out the embodiments as shown and described is well within the scope of a person of ordinary skill in the art.

Even though the embodiments have been described above with reference to examples according to the accompanying drawings, it is clear that the embodiments are not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. A controller comprising:
at least one processor; and
at least one memory including computer program code, the at least one memory and computer program code being configured, with the at least one processor, to cause the controller to:
maintain information on requirements of data traffic to be handled by a pool of terminal devices and data traffic statistics for the pool of terminal devices;
receive results of scanning of available radio access networks and capabilities of said available radio access networks by one or more primary terminal devices of the pool of terminal devices from the one or more primary terminal devices via one or more first signaling interfaces between the controller and the one or more primary terminal devices;
analyze the results of the scanning, the requirements of the data traffic and the data traffic statistics to determine optimal radio access configurations for the pool of terminal devices for satisfying the requirements of the data traffic;
configure the pool of terminal devices for providing radio access according to the optimal radio access configurations via signaling interfaces between the controller and the pool of terminal devices; and
provide radio access using the pool of terminal devices according to the optimal radio access configurations.

2. The controller of claim 1, wherein the the at least one memory and the computer program code are further configured, with the at least one processor, to cause the controller to:
Transmitting transmit, before the receiving of the results of the scanning, a request for scanning radio access networks available for the one or more primary terminal devices and capabilities thereof to the one or more primary terminal devices of the pool of terminal devices.

3. The controller according to claim 2, wherein the the at least one memory and the computer program code are further configured, with the at least one processor, to cause the controller to repeat the transmitting of the request, the receiving of the results of the scanning, the analyzing and the configuring periodically.

4. The controller according to claim 1, wherein the at least one memory and the computer program code are further configured, with the at least one processor, to cause the controller to:
receive the information on the requirements of the data traffic to be handled by the pool of terminal devices from a computing device via a wireless or wired communication link;
store the information on the requirements of the data traffic to be handled by the pool of terminal devices to the memory; and
provide radio access for the computing device using the pool of terminal devices, wherein a combination of the controller and the pool of terminal devices is seen as a singular terminal device from a point of view of said computing device.

5. The controller according to claim 4, wherein the computing device is an Industrial Internet of Things, IIoT, device or an Internet of Things, IoT, device.

6. The controller according to claims claim 1, wherein the information on the requirements of the data traffic to be handled by the pool of terminal devices comprises information on one or more expected bit rates of the data traffic, one or more expected reliabilities associated with the data traffic and/or one or more expected availabilities associated with the data traffic.

7. The controller according to claim 1, wherein the capabilities of one or more available radio access networks indicated in the results of the scanning comprise at least supported frequency bands of the one or more available radio access networks and the at least one memory and the computer program code are further configured, with the at least one processor, to cause the controller to determine the optimal radio access configurations so as to provide increased reliability according to one or more of the following:
optimal radio access configurations for at least two terminal devices in the pool of terminal devices correspond to a duplication of a data stream of the data traffic using different frequency bands and/or different radio access networks in said at least two terminal devices,
at least one optimal radio access configuration for at least one corresponding terminal device in the pool of terminal devices corresponds to a duplication of a data stream of the data traffic in a single terminal device using two different frequency bands and/or two different radio access networks and
optimal radio access configurations for at least two terminal devices in the pool of terminal devices are defined so as to avoid concurrent handover with said at least two terminal devices.

8. The controller according to claim 1, wherein the determining of the optimal radio access configurations comprises:
determining which terminal device or devices in the pool to use for handling which data stream of the data traffic; and
determining, for each terminal device to be used, which radio access network to use and which capabilities to indicate to said radio access network based on availability of Subscriber Identity Module, SIM, cards in the pool of terminal devices, the capabilities to be indicated comprising at least capabilities regarding supported frequency bands.

9. The controller according to claim 1, wherein the at least one memory and the computer program code are further configured, with the at least one processor, to cause the controller, when configuring the pool of terminal devices for the first time, to perform:
collecting collect, before the maintaining, the data traffic statistics for the pool of terminal devices by receiving data traffic statistics for the pool of terminal devices from a remote computing device from via a second signaling interface and/or by carrying out one or more dedicated trials with the pool of terminal devices;
storing store the data traffic statistics to the memory;
transmitting transmit, before the receiving of the results of the scanning for a first time, an initialization command for initializing the one or more primary terminal devices and scanning radio access networks and capabilities of said radio access networks available for the one or more primary terminal devices to the one or more primary terminal devices of the pool of terminal devices, wherein the at least one memory and the computer program code are further configured, with the at least one processor, to cause the controller to configuring configure, when configuring the pool of terminal devices for the first time, by:
in response to the pool of terminal devices comprising one or more secondary terminal devices, transmitting to the one or more secondary terminal devices an initialization and configuration command for initializing and configuring the one or more secondary terminal devices according to optimal radio access configurations determined by the controller via one or more corresponding signaling interfaces; and
transmitting a configuration command for reconfiguring the one or more primary terminal devices according to an optimal radio access configuration determined by the controller to the one or more primary terminal devices via the one or more first signaling interfaces.

10. The controller according to claim 1, wherein the at least one memory and the computer program code are further configured, with the at least one processor, when configuring the pool of terminal devices any time after an initial configuration of the pool of terminal devices, to perform cause the controller to:
maintain information on current radio access configurations of the pool of terminal devices in the memory;
comparing compare, in response to the analyzing, the optimal radio access configurations to the current radio access configurations of the pool of terminal devices;
performing perform the configuring of the pool of terminal devices according to the optimal radio access configurations only in response to an optimal radio access configuration for at least one terminal device differing from a corresponding current radio access configuration; and
storing store, in response to the configuring, information on the optimal radio access configuration as a current radio access configuration of the pool of terminal devices to the memory.

11. The controller according to claim 10, wherein the at least one memory and the computer program code are further configured, with the at least one processor, to cause the controller to, in response to an optimal radio access configuration for at least one terminal device differing from a corresponding current radio access configuration, by:
transmitting, to each of said at least one terminal device via a corresponding signaling interface, a configuration command for reconfiguring a corresponding terminal device according to a corresponding optimal radio access configuration.

12. The controller according to claim 1 wherein the at least one memory and the computer program code are further configured, with the at least one processor, to cause the controller to perform periodically after an initial configuration of the pool of terminal devices:
evaluating a quality of a data flow associated with the pool of terminal devices;
comparing the quality of the data flow against pre-defined criteria for the quality of the data flow; and
transmitting, in response to determining that the quality of the data flow fails to satisfy the pre-defined criteria, to one or more terminal devices in the pool of terminal devices via one or more corresponding signaling interfaces one or more configuration commands for reconfiguring said one or more terminal device so as to satisfy the pre-defined criteria for the quality of the data flow.

13. The controller according to claim 1, wherein the at least one memory and the computer program code are further configured, with the at least one processor, to cause the controller to:
Changing change an assignment of at least one terminal device in the pool of terminal devices from a primary terminal device to a secondary terminal device or from a secondary terminal device to a primary terminal device so as to enable more comprehensive scanning of radio access network and capabilities thereof.

14.-19. (canceled)

20. A primary terminal device comprising:
at least one processor; and
at least one memory including computer program code, the at least one memory and computer program code being configured, with the at least one processor, to cause the primary terminal device to:
scan radio access networks available for the primary terminal device and capabilities of said radio access networks;
transmit results of the scanning to a controller via a first signaling interface between the primary terminal device and the controller, wherein the controller is configured to control a pool of terminal devices comprising the primary terminal device; and
configure, in response to receiving a configuration command to provide radio access according to an optimal radio access configuration from the controller via the first signaling interface, the primary terminal device according to the configuration command.

21.-24. (canceled)

25. A method comprising:
scanning radio access networks available for a primary terminal device and capabilities of said radio access networks;
transmitting results of the scanning to a controller via a first signaling interface, wherein the controller is configured to control a pool of terminal devices comprising the primary terminal device; and
configuring, in response to receiving a configuration command to provide radio access according to an optimal radio access configuration from the controller via one or more first signaling interfaces, the primary terminal device according to the configuration command.

26. A non-transitory computer readable medium comprising program instructions for causing an apparatus to perform at least the following:
scanning radio access networks available for a primary terminal device and capabilities of said radio access networks;
transmitting results of the scanning to a controller via a first signaling interface, wherein the controller is configured to control a pool of terminal devices comprising the primary terminal device; and
configuring, in response to receiving a configuration command to provide radio access according to an optimal radio access configuration from the controller via the first signaling interface, the primary terminal device according to the configuration command.

27. The primary terminal device of claim 20, wherein the at least one memory and the computer program code are further configured, with the at least one processor, to cause the primary terminal device to scan in response to receiving a request for scanning radio access networks and capabilities of said radio access networks available for the primary terminal device from the controller via the one or more first signaling interfaces and/or in response to initializing the primary terminal device, the initializing being performed in response to receiving an initialization command for initializing the primary terminal device and scanning radio access networks and capabilities of said radio access networks available for the primary terminal device from the controller via the one or more first signaling interfaces.

28. The primary terminal device of claim 20, wherein the at least one memory and the computer program code are further configured, with the at least one processor, to cause the primary terminal device to configure by:
attaching to the radio access network defined in the configuration command; and
indicating only the capabilities defined in the configuration command to the radio access network.
